(19) United States
(12) Patent Application Publication
(10) Pub. No.: US 2011/0134733 A1
(43) Pub. Date: Jun. 9, 2011

(54) TILT ADJUSTMENT CONTROL METHOD OF NEAR-FIELD OPTICAL SYSTEM

(75) Inventors: Wei-Chih LIN, Hsinchu (TW); George Leenknegt, Hsinchu (TW); Jan van de Ven, Hsinchu (TW)

(73) Assignee: LITE-ON IT CORPORATION, Taipei (TW)

(21) Appl. No.: 12/818,487

(22) Filed: Jun. 18, 2010

(30) Foreign Application Priority Data
Dec. 4, 2009 (CN) 200910253174.8

(51) Int. Cl. G11B 7/00

(52) U.S. Cl. 369/44.35; G9B/7

(57) ABSTRACT

A tilt adjustment control method for a near-field optical system is provided. The method includes the following steps. A gap between a lens and a disc is detected. A gain corresponding to the gap is provided. A tilt signal is detected. A tilt compensation value according to the tilt signal and the gain is obtained. A tilt adjustment control is performed on the lens according to the tilt compensation value.

This application claims the benefit of People's Republic of China application Serial No. 200910253174.8, filed Dec. 4, 2009, the subject matter of which is incorporated herein by reference.

### BACKGROUND OF THE INVENTION

1. Field of the Invention

The invention relates in general to a tilt adjustment control method of near-field optical system.

2. Description of the Related Art

For the existing disc technology, the increase in storage capacity can be implemented by way of multi-layered R/W discs or by reducing the size of the R/W focused light spots for increasing the storage capacity per layer, hence increasing the total storage capacity of a disc. The size of the focused light spots is normally determined according to the wavelength of the laser light and the numerical aperture (NA) of the optical system. In general, a light source with short wavelength and an optical system with large numerical aperture can generate small focused light spots.

Due to the development in the increase of the storage capacity of the disc in recent years, the wavelength of the laser light has become shorter and shorter, and the laser light has been changed from the infra-red light laser (for use in CD) to the red light laser (for use in DVD), and further to the blue light laser. Since the blue light laser is the shortest wavelength of the laser light which can be used in the optical disc system, the related development in increasing the storage capacity of the disc is directed to reading/writing a disc with a near-field optical system for generating smaller focused light spots by increasing NA value. To increase the NA value, the near-field optical system normally generates focused light spots with an assembly of an object lens (convex lens) and a solid immersion lens (SIL). When reading/writing a disc with a near-field optical system, the gap between the SIL and the disc surface would become even smaller such as about 30-100 nm if a blue light laser is used.

Since the perpendicularity between the focused beam and the disc data layer affects the capability and accuracy of an optical disc drive in the read/write of data, the drive normally performs tilt adjustment control on the optical system (or the optical head) during the read/write of data, so that the focused beam is perpendicular to the disc data layer. However, the SIL and the disc surface are very close when a near-field optical system is used for reading/writing a disc. Therefore, how to perform the tilt adjustment control on the SIL and how to avoid the SIL colliding with the disc have become a prominent task for the industries.

### SUMMARY OF THE INVENTION

One example of the invention is directed to a tilt adjustment control method for a near-field optical system. When the tilt adjustment control is performed on the solid immersion lens (SIL), the tilt signal or the tilt compensation value of the SIL is calibrated according to the corresponding gains of different gaps between the SIL and the disc, to avoid the SIL tilt being erroneously adjusted.

According to a first example of the present invention, a tilt adjustment control method for a near-field optical system is provided. The method includes the following steps. A gap between a lens and a disc is detected. A gain corresponding to the gap is provided. A tilt signal is detected. A tilt compensation value according to the tilt signal and the gain is obtained. A tilt adjustment control is performed on the lens according to the tilt compensation value.

The invention will become apparent from the following detailed description of the preferred but non-limiting embodiments. The following description is made with reference to the accompanying drawings.

### BRIEF DESCRIPTION OF THE DRAWINGS

FIG. 1A shows a relation between an SIL and a disc;

FIG. 1B shows a relation diagram of the tilt margin vs. the gap;

FIG. 1C shows an assembly diagram of an object lens and an SIL;

FIG. 2A shows a photo detection IC;

FIG. 2B shows a relation diagram of the gap error signal (GES) vs. the gap D;

FIG. 3A shows a relation diagram of the tilt angle (TA) of the SIL vs. the tilt signal TS under different D values;

FIG. 3B shows a relation diagram of the tilt angle (TA) of the SIL of FIG. 3A vs. a first order differential coefficient of the tilt signal TS under different D values; and

FIG. 4 shows an operation flowchart according to an embodiment of the invention.

### DETAILED DESCRIPTION OF THE INVENTION

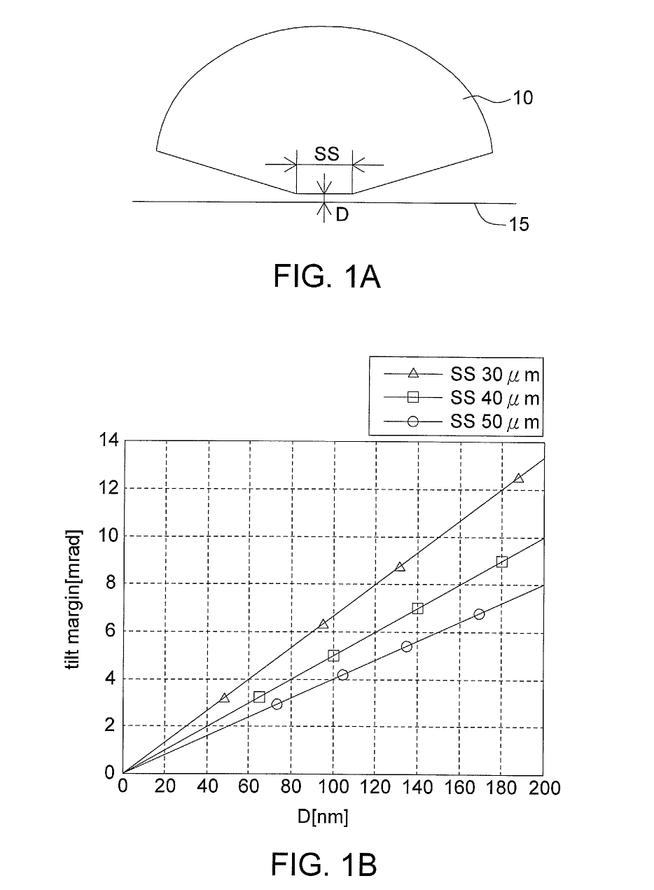

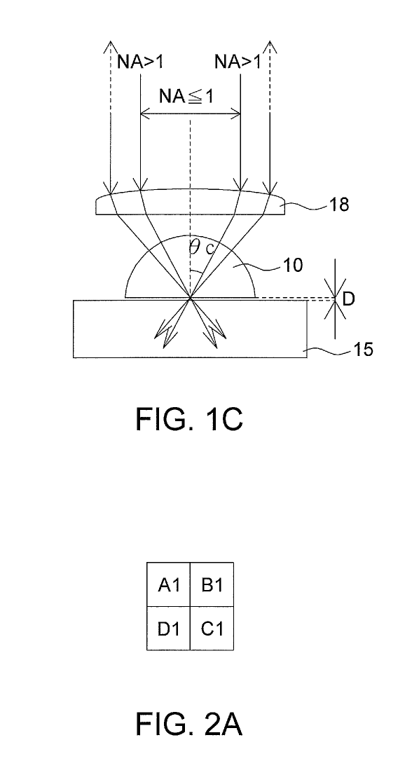

FIG. 1A shows a relation between an SIL and a disc. FIG. 1B shows a relation diagram of the tilt margin vs. the gap. In the present embodiment, the gap refers to the gap between the SIL and the disc surface, and the tilt margin refers to the maximum tilt of the SIL. In general, the tilt margin is related to the structure of the SIL and the gap between the SIL and the disc surface.

In FIG. 1A, the distance SS denotes the tip size of the SIL 10; and the distance D denotes the gap between the SIL 10 and the surface of the disc 15. In general, the tip size of the SIL 10 is about 40 μm. As indicated in FIG. 1B, if the gap D is about 100 nm and the tip size of the SIL 10 is about 40 μm, then the tilt margin is about 5 mrad (about 0.275 degrees). This implies that under such circumstance, the tilt angle (the angle contained by the tip surface of the SIL and the surface of the disc) of the SIL must not exceed 5 mrad otherwise the tip of the SIL will collide with the disc.

Referring to FIG. 1C, an assembly diagram of an object lens 18 and the SIL 10 in a near-field optical system is shown. As indicated in FIG. 1C, the lens 18 converges parallel lights into beams entering the SIL 10 at different incoming angles. According to the formula: NA=n_{SIL}*sin θ (wherein, n_{SIL} denotes the refractive index of a SIL and θ denotes incoming angle of a beam), the beams entering the SIL 10 at different incoming angles have different NA values. The incoming angle with the NA value being equal to 1 is defined as a total reflective angle θ_{c}. Let the NA value being equal to 1 be used as a demarcation. If the NA value of the beam entering the SIL 10 is smaller than 1 (that is, the incoming angle of the beam is smaller than the total reflective angle θ_{c}), then the beam will penetrate the SIL 10. To the contrary, if the NA value of the beam entering the SIL 10 is larger than 1 (that is, the incoming angle of the beam is larger than or is equal to the total reflective angle θ_{c}), then the beam will be totally reflected by the SIL 10.

For the near-field optical system to form focused light spots on the disc 15, the gap D between the SIL 10 and the surface of the disc 15 must be far smaller than the wavelength λ of the incoming light. In general, the gap D<=λ/10. Under this condition (the gap D<<λ), the beam whose NA value is smaller than 1 will penetrate the SIL 10 and will be focused on the disc. However, the area of focused light spots of the beam is too large to be used for reading/writing the grooves and the recording marks whose sizes are smaller than the focused light spots. To the contrary, the beam whose NA value is larger than 1 will be totally reflected by the SIL 10 before the gap between the SIL 10 and the surface of the disc enters into the near-field region. However, if the distance between the SIL 10 and the surface of the disc 15 enters into the near-field region (if the gap D<=λ/10), due to the photon tunneling effect, the beam whose NA value is larger than 1 will penetrate the gap D and will be focused on the disc 15. In the near-field optical system, the drive reads/writes discs with the smaller focused light spots formed by the beam whose NA is larger than 1. Besides, the focused light spots formed by the beam whose NA is smaller than 1 and the focused light spots formed by the beam whose NA is larger than 1 are focused on different planes, so the problem of mutual interference will not occur.

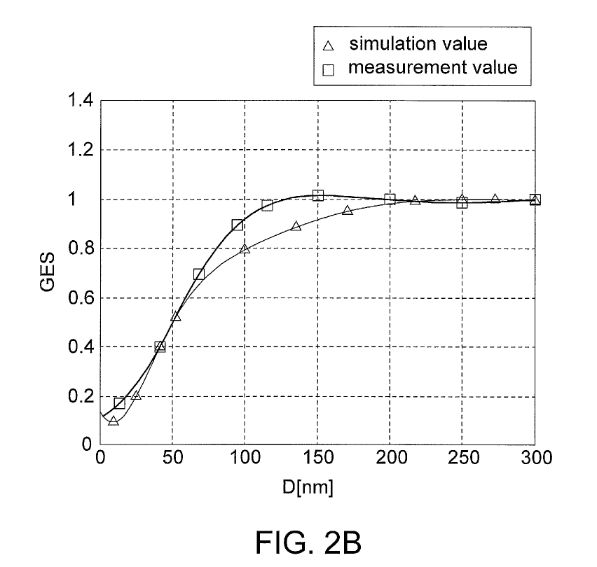

When the beam focused on the disc is reflected to the near-field optical system from the disc, the reflective light will be received by the photo detection IC (PDIC) such as a quadrant photodiode, as indicated in FIG. 2A. After the PDIC receives the reflective light reflected from the disc, the four phases A1˜D1 of the PDIC respectively receive and sense the signal intensity of the reflective light located in the respective phase. The tilt signal TS of the SIL is obtained by deducting the light signal intensity received by the phases of a half of the PDIC from the light signal intensity received by the phases of the other half of the PDIC. In general, the tilt signal TS can be designed as: TS=(A1+D1)−(B1+C1) or TS=(B1+C1)−(A1+D1). For another tilt direction, the other tilt signal TS can be as: TS=(A1+B1)−(C1+D1) or TS=(C1+D1)−(A1+B1). The tilt direction refers to the radial direction or the tangent direction.

The tilt signal TS can be obtained from the light signal intensity received by the PDIC, and the gap error signal (GES) can be obtained from the sum of the signal intensity received by the PDIC, that is, GES=A1+B1+C1+D1. FIG. 2B shows a relation diagram of the gap error signal (GES) vs. the gap D. As indicated in FIG. 2B, when the SIL approaches the disc (that is, the gap D becomes smaller), the gap error signal GES gradually decays. When the gap D is smaller than 100 nm (that is, when the SIL enters into the near-field region), the gap error signal GES presents linear decay. Thus, the distances D between the disc and the SIL when the SIL is in the near-field region can be obtained from the gap error signal GES.

In the near-field optical system, as for the tilt adjustment on the SIL, the tilt angle of the SIL is obtained according to the tilt signal TS, so that the tilt compensation value of the SIL is obtained for adjusting the tilt angle of SIL.

However, even if the values of the tilt signal TS are the same, the actual tilt angle of the SIL varies with the gap D between the SIL and the disc.

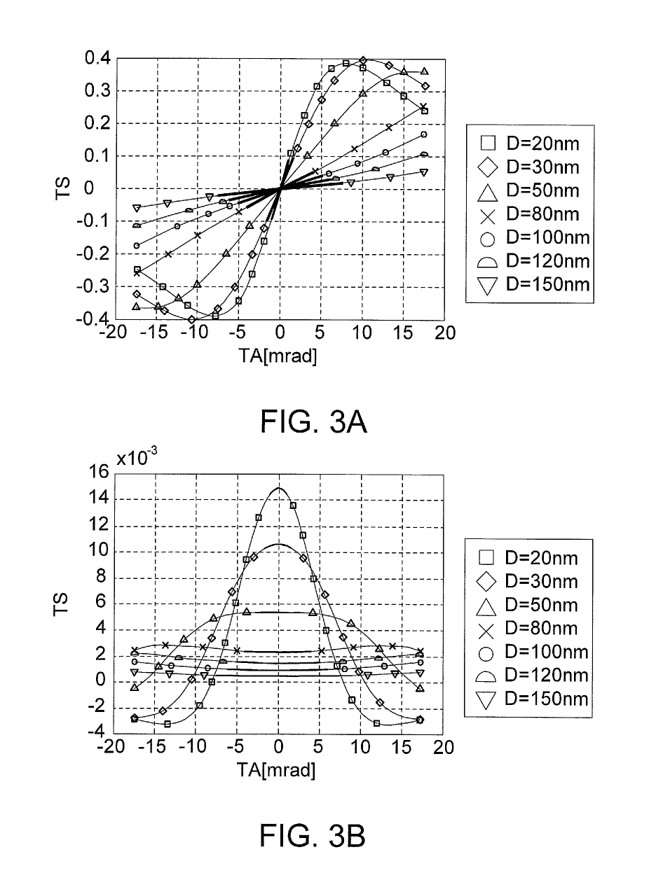

FIG. 3A shows a relation diagram of the tilt angle (TA) of the SIL vs. the tilt signal TS under different D values. FIG. 3B shows a relation diagram of the tilt angle (TA) of the SIL of FIG. 3A vs. the first order differential coefficient of the tilt signal TS under different D values.

Referring to FIG. 3A and FIG. 3B. When the gap D varies, the SIL will have different tilt margins (as indicated in FIG. 1), the range denoted by bolder lines denote the range which the SIL will not collide with the disc under the gap D. The closer the SIL approaches the disc (that is, the gap D becomes smaller), the higher sensitivity the tilt signal TS has. That is, given the same tilt angle (TA) of the SIL, when the gap D becomes smaller, the value of the tilt signal TS detected by the PDIC becomes larger. Similarly, if the PDIC detects the same tilt signal TS, the smaller the gap D is, the smaller the actual tilt angle (TA) of the SIL will be. For example, if the tilt signal TS is 0.1 and the gap D is 20 nm, then the tilt angle (TA) is about 1 mrad; and if the tilt signal TS is 0.1 and the gap D is 50 nm, then the tilt angle (TA) is about 2.5 mrad.

According to the prior tilt adjustment control, the SIL is adjusted by the tilt compensation value corresponding to the tilt signal TS directly without considering the gap D between the SIL and the disc, wherein the tilt compensation value can be a tilt angle (TA). In prior art, the relation between the tilt signal TS and the tilt compensation value (for example, the tilt compensation value being 2.5 mrad if the tilt signal TS being 0.1) is defined based on 50 nm size gap D. Despite the actual gap D is 20 nm, if the adjustment of the SIL is still based on 2.5 mrad of the tilt compensation value, the tilt is over-compensated and even results in collision between the SIL and the disc.

Thus, calibration of the tilt signal TS and generation of a correct tilt compensation value have to consider respective signal gain under the reference gap and the actual gap. Therefore, when the tilt adjustment of the SIL is controlled by a closed loop feedback control in the near-field optical system, the gain of the closed loop feedback control varies with the change in the gap D. In greater details, provided that the tilt angle is the same, when the gap D becomes smaller, the tilt signal TS also becomes larger, so the gain of the feedback control must be reduced for calibrating the tilt signal TS and the corresponding tilt compensation value. Thus, the present embodiment of the invention provides automatic gain control for compensating the change in the gain.

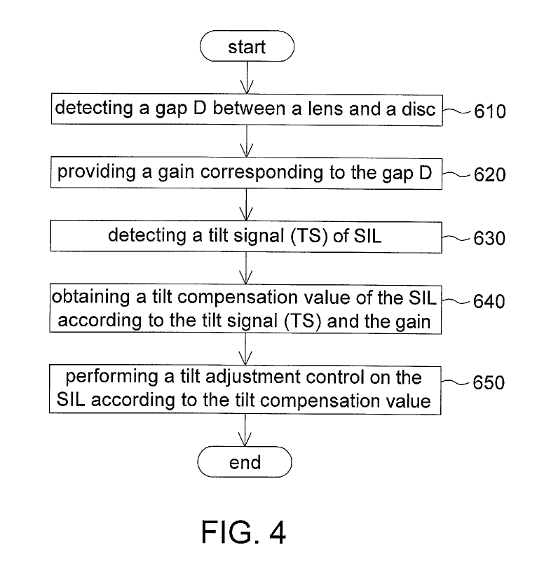

Referring to FIG. 4, an operation flowchart according to the embodiment of the invention is shown. At step 610, the gap D between the SIL and the disc is detected. In greater details, in the near-field optical system, there is a linear relation between the gap error signal GES and the gap D (between the SIL and the disc surface), so the gap D between the SIL and the disc can be obtained based on the gap error signal GES if the SIL is in the near-field region.

Next, at step 620, a gain corresponding to the detected gap D is provided. Under the same tilt signal TS, the actual tilt angle of the SIL varies with the change in the gap D between the SIL and the disc. In the present step, the corresponding gain is provided according to the detected gap D. Before the drive is delivered from the manufacturer, the gaps D and their corresponding gains can be obtained through test so as to obtain a gap-gain look-up table based on the relation between the tilt angle (TA) of the SIL and the tilt signal TS under different gap D (as indicated in FIG. 3A).

Then, at step 630, the tilt signal (TS) of the SIL is detected. As disclosed above, the tilt signal TS can be obtained by deducting the light signal intensity received by the phases of a half of the PDIC from the light signal intensity received by the other half of phases of the PDIC.

After that, at step 640, the tilt compensation value of the SIL is obtained according to the tilt signal (TS) and its corresponding gain. In the present step, the tilt signal (TS) is calibrated according to the gain first; and then the tilt compensation value of the SIL corresponding to the calibrated tilt signal TS is obtained according to the relation between the tilt compensation value and the tilt signal TS of the SIL under the reference gap. Alternatively, a reference tilt compensation value can be obtained first according to the relation between the tilt compensation value and the tilt signal TS of the SIL under the reference gap; and then the reference tilt compensation value is calibrated according to the gain for obtaining the tilt compensation value of the SIL. At step 650, the tilt adjustment control of the SIL is performed according to the tilt compensation value. In the present embodiment of the invention, the tilt adjustment control of the SIL can be performed in dynamic (in feedback).

According to the prior tilt adjustment control, the detected tilt signal is directly used as a tilt compensation value of the SIL for performing tilt adjustment control on the SIL. In the near-field optical system, the gap between the SIL and the disc is very close and the gap would affect the sensitivity of the tilt signal. To avoid the SIL colliding with the disc, the embodiment of the invention provides a tilt adjustment control which calibrates the tilt compensation value of the SIL according to the respective gain corresponding to respective gap size and the detected tilt signal, so that the tilt compensation value of the SIL is correct even if change in the sensitivity of the tilt signal, hence avoiding the SIL colliding with the disc.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A tilt adjustment control method for a near-field optical system, comprising:
detecting a gap between a lens and a disc;
providing a gain corresponding to the gap;
detecting a tilt signal;
obtaining a tilt compensation value according to the tilt signal and the gain; and
performing a tilt adjustment control on the lens according to the tilt compensation value.

2. The method according to claim 1, wherein the step of detecting the gap between the lens and the disc comprises:
detecting the gap between the lens and the disc according to a gap error signal.

3. The method according to claim 2, wherein the gap error signal is sum of light signal intensity received by all phases of a photo detection IC.

4. The method according to claim 1, wherein the tilt signal is obtained by deducting a second light signal intensity received by phases of a second half of a photo detection IC from a first light signal intensity received by phases of a first half of the photo detection IC.

5. The method according to claim 1, wherein the gain is obtained by looking up a gap-gain table.

6. The method according to claim 1, wherein the step of obtaining the tilt compensation value according to the tilt signal and the gain comprises:
calibrating the tilt signal according to the gain for obtaining a calibrated tilt signal; and
obtaining the tilt compensation value corresponding to the calibrated tilt signal according to a reference gap.

7. The method according to claim 1, wherein the step of obtaining the tilt compensation value according to the tilt signal and the gain comprises:
obtaining a reference tilt compensation value corresponding to the tilt signal according to a reference gap; and
calibrating the reference tilt compensation value according to the gain for obtaining the tilt compensation value.

8. The method according to claim 1, wherein the step of performing the tilt adjustment control on the lens according to the tilt compensation value comprises:
performing the tilt adjustment control by dynamic feedback.
